(19) United States
(12) Patent Application Publication
(10) Pub. No.: US 2017/0339747 A1
(43) Pub. Date: Nov. 23, 2017

(54) SYSTEMS AND METHODS FOR NETWORK DATA TRANSFER

(71) Applicant: .eTouches, Inc., Norwalk, CT (US)

(72) Inventors: Allen Houng, Taipei City (TW); Sambhav Galada, San Bruno, CA (US); Brian Friedman, San Francisco, CA (US)

(21) Appl. No.: 15/594,310

(22) Filed: May 12, 2017

Related U.S. Application Data
(63) Continuation of application No. PCT/US15/60751, filed on Nov. 13, 2015.
(60) Provisional application No. 62/079,466, filed on Nov. 13, 2014.

(51) Int. Cl. H04W 84/18; H04W 4/00; H04B 1/3827; H04W 72/04

(52) U.S. Cl. CPC H04W 84/18; H04W 4/008; H04B 1/385; H04W 72/0406

(57) ABSTRACT

Provided herein are systems and methods of transferring data between badges in an environment. The badges can simultaneously transmit and receive data. The badges can transmit and receive data without routing through a network gateway. The badges can transmit and receive data through a Bluetooth transmitter and receiver. At least a fraction of the badges can be connected to the network gateway. The badges can form a mesh such that devices can communicate by signal hopping. In some cases the badges can modulate their signal frequency to optimize battery usage.

### CROSS REFERENCE

This application is a continuation of International Application No. PCT/US2015/060751, filed on Nov. 13, 2015, which claims the benefit of priority to U.S. Provisional Patent Application No. 62/079,466 filed on Nov. 13, 2014, each of which is entirely incorporated herein by reference.

### BACKGROUND

Businesses often provide conferences for networking and/or marketing purposes. Persons attending the conferences can network with each other for the purpose of friendship, sales, and/or professional development. Vendors can also attend the conferences to identify potential customers, learn about consumer needs and/or interests, and/or network with other vendors.

### SUMMARY

Events can be planned to bring persons of similar interest, hobby, background, and/or vocation together for networking, learning, advertising, and/or communication. During an event an individual can interact with one or more other individuals, it can be advantageous to track the interactions of the individual. Provided herein are systems and methods for recording interactions that an individual can have at an event. These interactions can comprise interactions with other individuals, vendors, or attractions at the event. After the event and/or in real time during the event an individual can receive a summary report comprising contact information, advertisements, and details about the time location, and/or duration associated with an interaction at the event. The information can be collected and transmitted passively without intervention from the individual by a badge that is uniquely registered with the individual. In some cases, the badge can be a wearable device. The badge can be a simple device that does not execute matching or other programs to process data. As a result of the simple processes executed on the badge and minimal components required to perform functions of the badge, the badge can be provided at a relatively low price point and can have a relatively long battery life compared to devices that require more complicated functions.

Aspects of the invention are directed to a method of exchanging information in an environment between users, the method comprising: transmitting, from a badge, without routing through a network gateway, a signal with a packet comprising an identifier and a time stamp; receiving, at the badge, without routing through the network gateway, one or more signals with packets that contain data comprising an identifier and a time stamp from one or more other badges, wherein the badge simultaneously transmits the packet and receives the one or more packets; connecting to the network gateway; and transmitting data from the one or more packets to a hub through the network gateway.

In some embodiments, the badge may connect directly to the network gateway. The badge may connect to the network gateway by hopping to a badge that is directly connected to the network gateway. The badge may be a wearable device. The environment may be an event environment. The method may further comprise providing a summary report of packets that were received in the environment. The signal may be a Bluetooth signal.

The method may further comprise: determining whether the one or more other badges are connected to the network gateway; and transmitting data to at least one other badge when the at least one other badge is connected to the network gateway. The method may further comprise transmitting the data to the network gateway via a path comprising a smallest number of hops between any two of the one or more other badges that are connected to the network gateway. The method may further comprise reviewing packets received from the one or more other badges. The packets received from the one or more other badges may comprise at least connection status to the network gateway, signal strength, or distance from the network gateway. The method may further comprise synchronizing respective time keepers of the badge and the at least one other badge when the at least one other badge is connected to the network gateway.

The method may further comprise determining whether an available storage capacity of the badge is below a predetermined threshold value; and transmitting the data to the at least one other badge when the available storage capacity is below the predetermined threshold value. The method may further comprise receiving information associated with storage capacity of the at least one other badge. The method may further comprise retrieving the data transmitted to the at least one other badge when the available storage capacity of the badge is restored to equal to or above the predetermined threshold value.

Additional aspect of the invention may be directed to an electronic badge for exchanging information in an environment between users, the electronic badge comprising: a communication interface configured to transmit, without routing through a network gateway, a signal with a packet comprising an identifier and a time stamp; and a computer processor in communication with the communication interface. The computer processor may be programmed to receive, without routing through the network gateway, one or more signals with packets that contain data comprising an identifier and a time stamp from one or more other badges, wherein the electronic badge simultaneously transmits the packet and receives the one or more packets; and generate signals for connecting to the network gateway. The communication interface may be further configured to transmit data from the one or more packets to a hub through the network gateway when the electronic badge is connected to the network gateway.

In some embodiments, the electronic badge may further comprise one or more sensors configured to detect location or movement of the electronic badge. The electronic badge may further comprise a display having a graphical user interface for showing information associated with the one or more other badges. The communication interface may be further configured to be in network communication with an electronic device having a display having a graphical user interface for showing information associated with the one or more other badges.

The computer processor may be configured to receive, without routing through the network gateway, one or more signals from the one or more other badges at difference scanning frequencies when the electronic badge operates in different modes. The communication interface may be configured to transmit the signal without routing through a network gateway at different advertising frequencies when the electronic badge operates in different modes.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows a group of badges exchanging data in a peer-to-peer mesh network.

FIG. 2 shows a schematic of a badge architecture including components that can operate on the badge.

FIG. 3 shows a schematic of an advertisement packet that can be transmitted and/or received by a badge.

FIG. 4 shows a schematic scenario of a badge outside of a network gateway connecting to the network gateway by hopping a signal.

FIG. 5A shows a flow diagram of a functional implementation of a badge.

FIG. 5B shows an exemplary user interface for individual interaction associated with a functional implementation of a badge.

FIG. 6 shows a schematic of two devices communicating over time.

FIG. 7 shows a flow diagram of a badge transitioning between operation modes.

FIG. 8 shows a detailed flow diagram of a badge transitioning between operation modes.

FIG. 9 shows a schematic of individuals interacting through badge information exchange at an event.

FIG. 10 shows an example of a summary report that can be provided to an individual through a user interface.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Provided herein are systems and methods for transmitting and receiving signals between badges in an environment. The badges can simultaneously scan for other badges and advertise their presence to other badges in the environment. The badge can detect one or more other badges in the environment and obtain information identifying the badge and a time stamp indicating when the badge was detected. At least a fraction of the badges can be connected to a network gateway and the badges can form a mesh network such that all the badges can access the network gateway through hopping a signal.

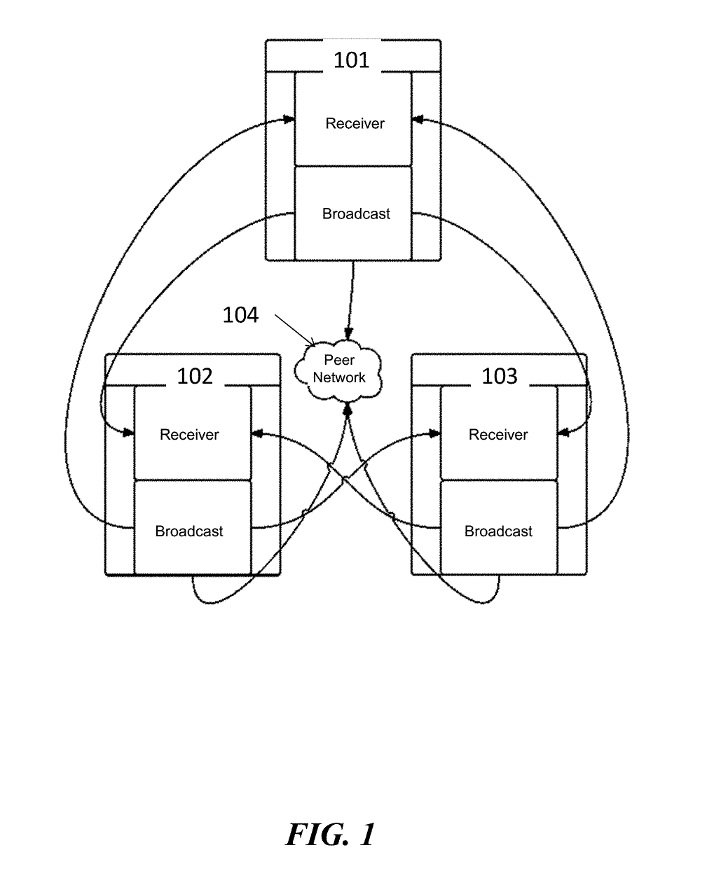

FIG. 1 shows a diagram of communication and sharing that can occur between badges as described herein. The badge can be configured to perform broadcasting and receiving of packets. A badge 101 can scan an area for other badges. The area can be an indoor area, an outdoor area, or a mixed indoor and outdoor area. The badge 101 can scan an area that has a predetermined size and/or predetermined boundaries, for example an area within a radius extending from a location of the badge 101. In some cases, the badge 101 can scan an area as defined by an area where a scanning signal from the badge can reach. The badge 101 can scan for broadcast packets from other badges in the area. The badge 101 can detect and receive a packet from one or more other badges 102 and/or 103. The packet can transfer proprietary information about the other badges to the badge 101. Proprietary information can comprise a badge ID, distance between the badge and another badge, and/or a time stamp indicating when the badge detected the other badge. The badge ID can be identification information stored on the badge that associates the badge with a specific individual or entity. A badge can simultaneously send packets with information about itself and receive packets with information about other badges in the area.

One or more badges can operate in a peer-to-peer network 104. Badges in the peer to peer network can communicate without routing a communication signal through a central server. The badges can communicate without connection to a network gateway connected device (e.g., smartphone, computer). In some cases at least one of the badges can be connected to a network gateway connected device. Other badges can access the network gateway by sending a signal through the network gateway connected badge.

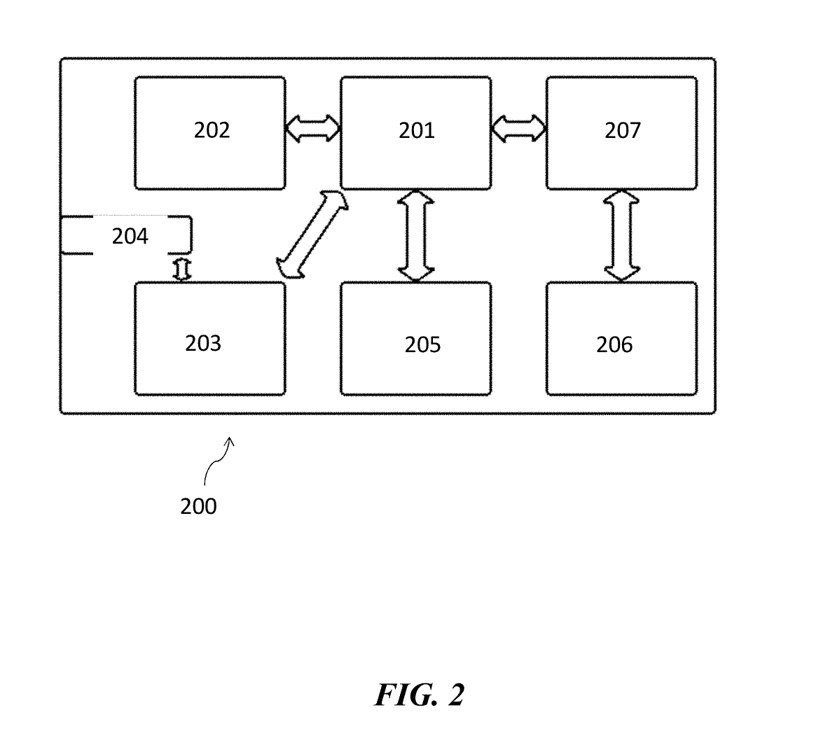

FIG. 2 shows a schematic example of a badge 200 as described herein. A badge can comprise one or more processor 201. The one or more processor can be a microprocessor. The processor can be in communication with a memory storage device 202. The memory storage device can be on-board or off-board the badge. The memory storage device can comprise program instructions for the processor 201 and/or badge ID information. The processor can communicate with the memory storage device through a wired or wireless connection. The processor can also communicate with a signal module 203. The signal module 203 can be a unit configured to receive and/or transmit a signal. In some cases the signal module 203 can be configured to receive and transmit a radio signal, for example a Bluetooth signal or another signal with limited range. The signal module can connect to an antenna 204 to receive and transmit a signal. The processors 201 can also be in communication with one or more sensors 205. The one or more sensors can be configured to detect movement and/or location of the badge. In some cases the sensors can comprise a global positioning sensor (GPS). The sensors can comprise an inertial measuring unit (IMU). The IMU can be a 6-axis or 9-axis sensor array. The IMU can comprise a gyroscope, accelerometer, and/or a magnetometer. The processor can be programmed to execute a sensor fusion program to interpret one or more data points from the IMU to determine a location and pose of the badge. The sensor data can be analyzed to determine the velocity, orientation, and/or gravitational force on the badge.

The badge can comprise a time keeping device (e.g., clock) that can generate a time stamp. A time stamp can be generated using the time keeping device to log a time at which the badge transmits and/or receives a signal. The time keeping device can generate consecutive time stamps each time a badge transmits and/or receives a signal. The time stamps can be processed to determine a duration of time during which two or more badges exchanged, received, and/or transmitted one or more signals.

The badge can be powered by a battery 206. The battery can be a rechargeable or disposable battery. The voltage output of the battery can be controlled by a voltage regulator 207. The voltage regulator can control the voltage output of the battery such that the battery use is optimized to increase the battery life. The voltage regulator can control the battery voltage based on an operating state of the device. Details of the operating states and transitions between the operating states will be discussed in detail.

The badge can be a wearable badge such that the badge can be worn or attached to the body of a user. The badge can be provided as part of a wrist band, arm band, leg band, ankle band, belt, necklace, pin, or any other item configured to attach to the body or clothing of a user. In some cases, the badge can be provided on a lanyard worn around the neck of a user. The badge can be worn instead of or in addition to a name tag, such as a name tag provided at a conference and/or networking event.

A badge can be registered with a unique identifier by connecting the badge to an internet gateway. An internet gateway connection can be a router or a proxy server. In some cases, the badge can route to a network gateway through a connection with a host computer, smartphone, or tablet. The internet gateway can facilitate communication between the badge and a hub, a hub can be a server (e.g., cloud computing system). The unique identifier can point to a specific individual or user. The unique identifier can be a name of an individual or entity that is associated with the badge. The unique identifier can additionally comprise contact or advertising information and/or links to contact or advertising information associated with the individual or entity. An administrator can register one or more badges before providing the badges to a group of users. The administrator can be an event organizer or manager and the group of users can be one or more users that will exchange information at the event. For example, an administrator can be a conference organizer and the group of users can be conference attendees. Upon arrival at the conference each user can receive a badge that has been registered by the conference organizer. The badge can be registered with a unique identifier that corresponds to each conference attendee.

A user can manage the badge through an application that executes on an electronic device (e.g., computer, smartphone, or tablet) that is in communication with the badge. In some cases the badge may or may not comprise a display with a user interface that can permit a user to manage the badge. The user interface may include a graphical user interface (GUI) with one or more graphical elements that permit said user to provide user inputs on the GUI. A user can receive a badge from an administrator, in some cases, the badge received from the administrator can already be initialized with information about the user, for example user identification information. After receiving the badge from the administrator the user can manage privacy settings of the badge through the application. For example, the user can manage what kind of information the badge transmits to other badges in a proximity of the badge. The user can request that the badge receive permission from the user before sending information to other badges in the proximity.

One or more badges can communicate by sending signals wirelessly. The one or more badges can communicate directly without routing a signal through a host machine. In some cases the one or more badges can communication by sending signals over Bluetooth. The one or more badges can form a mesh network to transmit and receive signals between badges. The one or more badges can send and receive signals from any Bluetooth enabled device, for example, smartphones, smart glasses, smart watches, tablets, or any other device capable of sending and/or receiving a Bluetooth signal.

One or more badges and/or one or more network gateways can be in communication to form a network mesh. One or more of the badges in the mesh can be connected to a network gateway. The one or more badges that are connected to the network gateway can communicate with a server (e.g., cloud computer system) to transmit and store data on the server. Additionally the one or more badges connected to the network gateway can contact the gateway to sync a time keeping device on the badge to maintain time stamp accuracy. Badges that are not connected to the network gateway can connect to the gateway by hopping from one badge to the next in the mesh until they reach a badge that is connected to the gateway. The mesh can permit badges to send signals to other badges outside of their proximity through hopping.

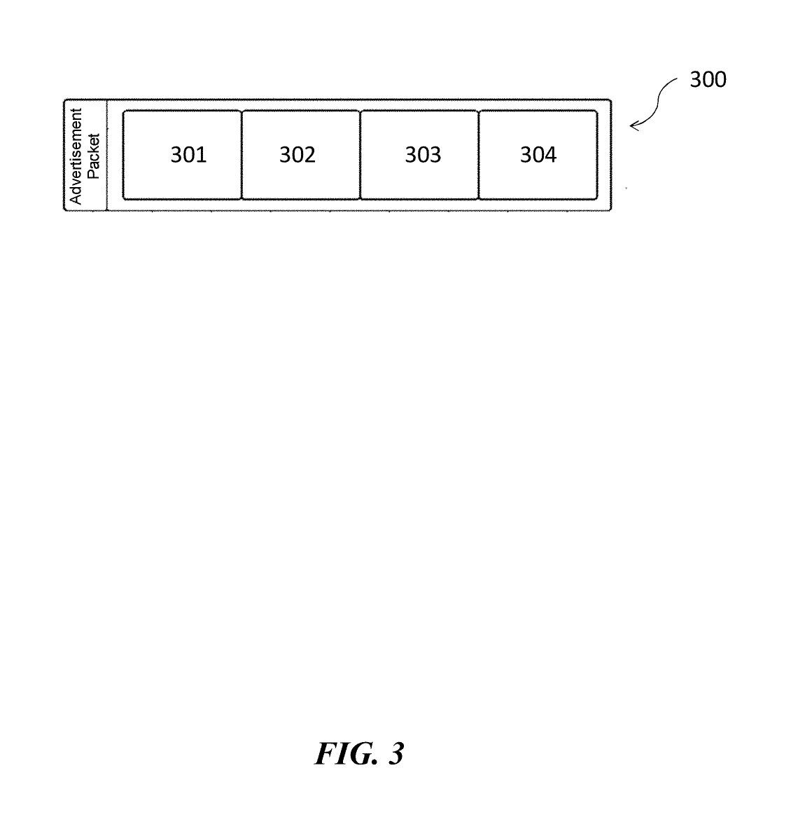

A badge can send a signal to advertise presence of the badge. The badge can send out an advertising packet. FIG. 3 shows a diagram of an example of a packet that can be transmitted and/or received by a badge. The packet 300 can have a header 301. The header can be the first information that is read by a badge receiving the packet. The header can provide information about the data in the packet including information about the sender, how the information should be processes, and/or what kind of badge transmitted the packet. The packet can also include a payload. The payload can have badge data 302. The badge data can include information about the badge that transmitted the packet including the unique badge identifier, a time stamp indicating when the packet was generated, a time stamp indicating when the packet was transmitted, signal strength, connection status to a gateway, distance from a gateway connected badge, and/or battery condition (e.g., remaining voltage). The payload can have information about the gateway status of the badge that transmitted the packet 303. The gateway status can indicate if the badge is connected to a gateway or not connected to a gateway. The gateway status can indicate that the badge is connected to a gateway directly or indirectly. An indirect gateway connection can occur when a badge is connected to a gateway by communicating with another badge that is directly connected to a gateway. The payload can communicate the degrees (e.g., number of badge) that a badge is away from a gateway connected badge. The payload can also have information about the state of the badge that transmitted the packet 304. The state of the badge can describe the scan rate of the badge and whether the badge is in sleep or power mode.

In addition to transmitting packets a badge can simultaneously receive packets. A badge can receive a packet and read the header of the packet to determine if the packet was transmitted by a badge or a gateway connected device (e.g., computer or smartphone). When the badge detects a packet from a gateway connected device, the badge can connect to the gateway connected device. Connecting to the gateway connected device can permit the badge to communicate with a server (e.g., hub). When the badge detects and connects to the network gateway the badge can update the gateway status in a packet transmitted by the badge. The badge can read the header data and confirm that the packet has been transmitted by either a badge or a gateway connected device, once the header data is confirmed the badge can read data stored in the packet payload. The data from the packet payload can be stored with the time stamp and signal strength. The data can be stored on a memory storage on-board or off-board the badge.

In some cases, one or more of the badges can be connected to a network gateway. Badges connected to the network gateway can tell other badges in the mesh network that they are connected to the network gateway. Badges connected to the gateway can synchronize time with the gateway. Badges that are not connected to the gateway can periodically connect to the gateway by connecting to one or more badges that are connected to the gateway to synchronize time with the gateway. In some cases, a badge can connect to a gateway directly or indirectly to update the host with the badge's battery life.

One or more badges can form a mesh network. The mesh can permit communication between one or more badges in the network. A badge can communicate with another badge that is outside of a range of a signal emitted by the badge by hopping between one or more intermediate badges until the badge outside of the signal range is reached. The mesh network can be a peer-to-peer network such that the badges perform decentralized communication. The badges in the network can have equal permissions and can be capable of performing similar or equivalent functions.

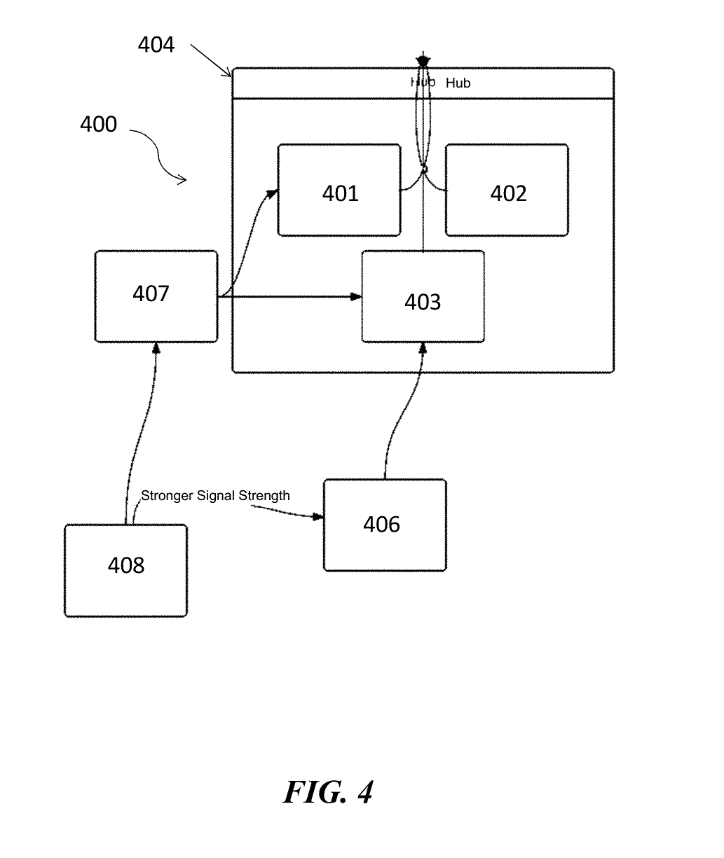

FIG. 4 shows an example of communication that can occur between badges in a network mesh. In the mesh 400 at least a fraction of the badges can be connected to a network gateway, for example, badges 401, 402, and 403 can be connected to the network gateway 404. Some of the badges in the network mesh can be in a proximity of the gateway connected badges 401, 402, and 403. In the example shown in FIG. 4 badges 406 and 407 can be in a proximity of the gateway connected badges. Two badges can be in proximity of each other when signal strength between the badges is strong enough to send and receive packets. Some badges in the network mesh can be outside of a proximity of the gateway connected badges. In FIG. 4 badge 408 can be outside a proximity of the gateway connected badges 401, 402, and 403. The badge 408 can that is outside a proximity of the gateway connected badges can be within a proximity of the badges that are within the proximity of the gateway connected badges 406 and/or 407. In some cases, the badge 408 that is outside a proximity of the gateway can connect to the gateway by hopping a signal from the badge 408 to the badges that are within the proximity of the gateway connected badges 406 and/or 407 to the gateway connected badges 401, 402, and 403. Badge 408 can choose to hop a signal to the gateway through badge 406 if badge 406 has a stronger signal strength. Badge 408 can be two degrees removed from a gateway connected badge such that badge 408 can connect to the gateway by hopping two times to reach a gateway connected badge. Badges outside the proximity of the gateway can connect to the gateway by hopping a signal to a gateway connected badge by hopping the signal at least 1, 2, 3, 4, 5, 6, 7, 8, 9, 10, or more times.

One or more processors on-board or off-board the badge can be programmed to determine an optimal route from a badge that is not connected to the gateway to a gateway connected badge. The programming can consider number of hops and signal strength between badges in the route to optimize either or both of battery usage and signal transmission time. In some cases, the shortest number of hops can be the optimal route. Alternatively, a route with more hops but stronger signal strength between hopped badges can be the optimal route.

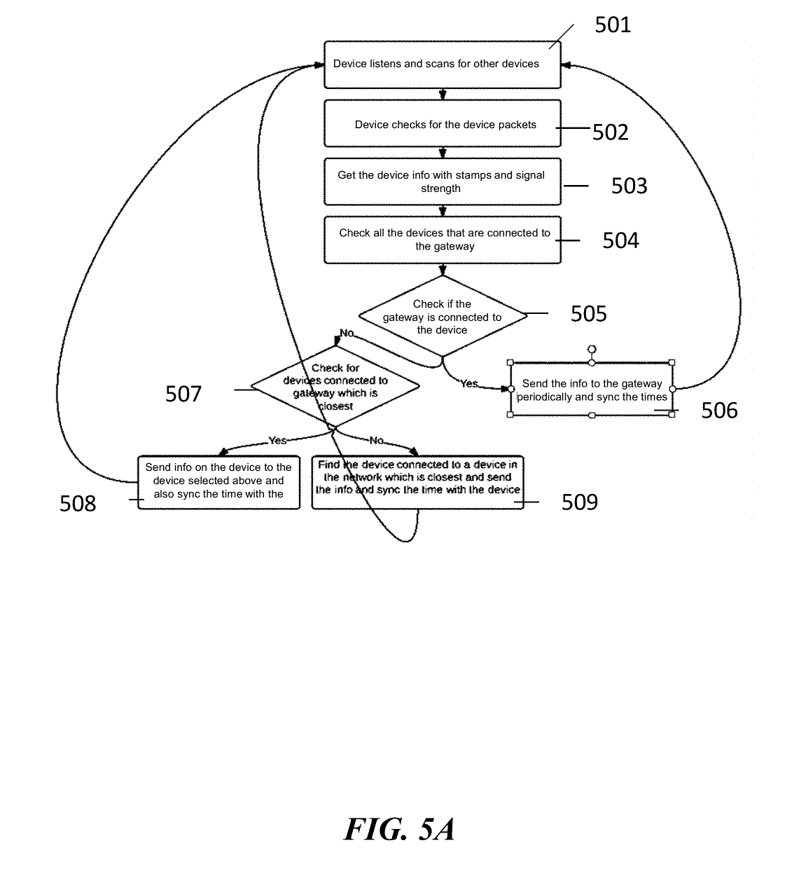

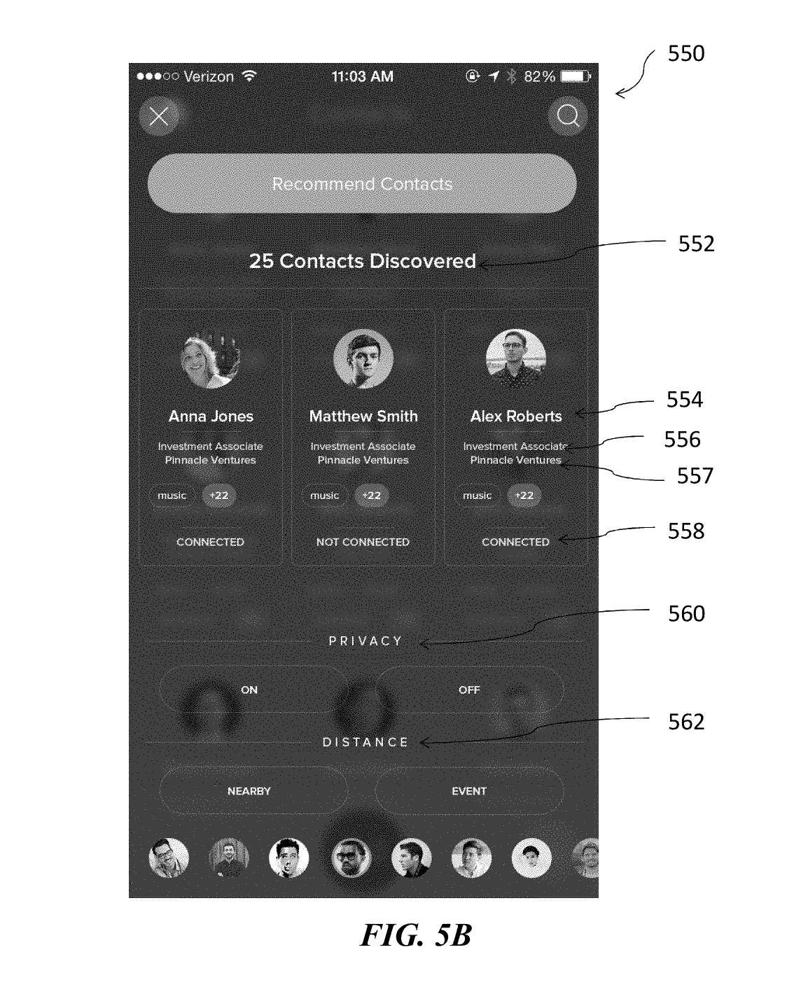

FIG. 5A shows a flow chart describing functional processes that can be performed by the badge. The badge can listen and scan for the presence of other badges in an environment 501. The badge can detect the presence of other badges in the environment by receiving packets emitted by one or more other badges. The badge can simultaneously advertise by emitting one or more packets while listening and scanning for other badges. When the badge detects on or more packets the badge can check the packet 502. The badge can check that packet by reading the packet header to determine if the packet originated from another badge or an alternate device. If the packet header indicates that the packet originated from another badge or another supported device that badge can continue reading the packet to get information about the other badge or other supported device 503. The information can comprise a time stamp indicating when the packet was sent and/or a signal strength associated with the other badge or other supported device. The badge can further determine from one or more packets received from the one or more other badge or other supported device whether the other badge or other supported device is connected to the network gateway 504. The badge can then determine if it is connected to the network gateway 505. If the device is connected to the network gateway it can send information to the gateway periodically and sync a time keeper on the badge with a gateway time keeper 506. The badge can also send information to the gateway about the packets that is received from other badges and/or supported devices and time stamp information associated with the receipt.

If the badge is not connected to the network gateway the badge can choose to send information to the network gateway through another badge or supported device in its proximity. The badge can review packets received from other badges and/or supported devices in the proximity of the badge to determine which of the badges and/or other supported devices is physically closest to the network gateway 507. A device that is closest to the network gateway can have a relatively stronger signal with the network gateway and can be able to transfer information to the network gateway relatively faster than devices that are less close to the network gateway. Once the badge has determined which other badge in its proximity is closest to the gateway the badge can hop information to the gateway through the other badge that is closest to the gateway 508. In some cases, the badge can also sync the time keeper on the badge with a time keeper on the other badge that is closest to the gateway. If none of the badges in the proximity of the badge are connected to the network gateway the badge can determine which of the other badges, if any, are in a proximity of another badge that is connected to the network gateway. The badge can continue to iterate outward until it finds a path of badges that lead to a badge that is connected to the network gateway. The badge can choose to connect to the gateway using the shortest available path (e.g., fewest number of hops). Once the badge establishes a path of badges that connect to the network gate way the badge can hop a signal to transmit information to the network gateway and sync a time keeper with the gateway or a badge connected to the gateway 509. A badge can sync with the gateway after every scan of badges in its proximity.

FIG. 5B shows an exemplary user interface 550 for individual interaction associated with a functional implementation of a badge. The user interface may be shown on a display of the badge. Alternatively or additionally, the user interface may be shown on a display of an electronic device (e.g., computer, smartphone, or tablet) associated with the user of the badge. For example, as discussed elsewhere herein, an application may be executed on the electronic device that is in communication with the badge. The user interface may be shown in the application which can permit the user to manage various functionalities of the badge.

For example, the user interface associated with a badge may show the number 522 of badges that have been detected in the environment. For example as discussed elsewhere herein, the badge may detect the presence of other badges in the environment by receiving from and transmitting packets to other badges in the environment. The user interface may display user information associated with the detected badges, which may include, but is not limited to, user name 554, title 556, and/or affiliation 557. The badge may further check whether the detected one or more other badges are connected to the network gateway. The user interface may then display the connection status 558, e.g., connected or not connected, of the individual badges.

In some instances, after discovering one or more badges in proximity, the user may select to tag one or more detected badges and/or one or more users associated with the detected badges. The tagging information may be stored to be associated with each badge and/or the user of the badge in the user's contacts. The tagging information may be used for later searching and/or exploring the user's contacts. The tagging information may also be shared with other users and their associated badges. Additionally, the user may create tagging information about oneself to be stored in one's own badge and this tagging information may be searchable for other users. The tagging information may include, but is not limited to, nicknames, connection status, occupations, hobbies, preferences about social connection, and/or combinations thereof.

The user interface may also provide privacy options 560 for the user to choose whether or not to share certain information with other badges or supporting devices in the mesh network. In some instances, the user interface can also provide privacy share settings for the user to determine what types of information can be shared and what types of information cannot be shared.

The user interface may further provide options for the user to define a distance/range 562 within which to scan for other badges. The user may choose to scan for other badges within a predetermined range, e.g., by pressing the “NEARBY” icon. The user may also be able to define the range, e.g., within a certain distance from a current location of the user or other position defined by the user. The user may also choose to scan for other badges associated with a particular event (e.g., a convention, a conference, a sporting event, a music event, a networking event, a fair, a trade show, and/or a shopping event) by pressing the “EVENT” icon. For example, when a user presses the “EVENT” icon, a list of events may be presented to user for selection. The list of events may be generated based on the current location of the user or other user profile data (e.g., hobbies, previously attended event(s), scheduled event(s) on user's calendar). Alternatively or additionally, the user may input certain key words or category of event(s) one is interested in, and search results may be presented to the user for confirmation and selection. The displayed event may or may not be related to the user's current location. The process and user interface described in FIGS. 5A-5B may be used for scanning for other badges for data transmission and receipt.

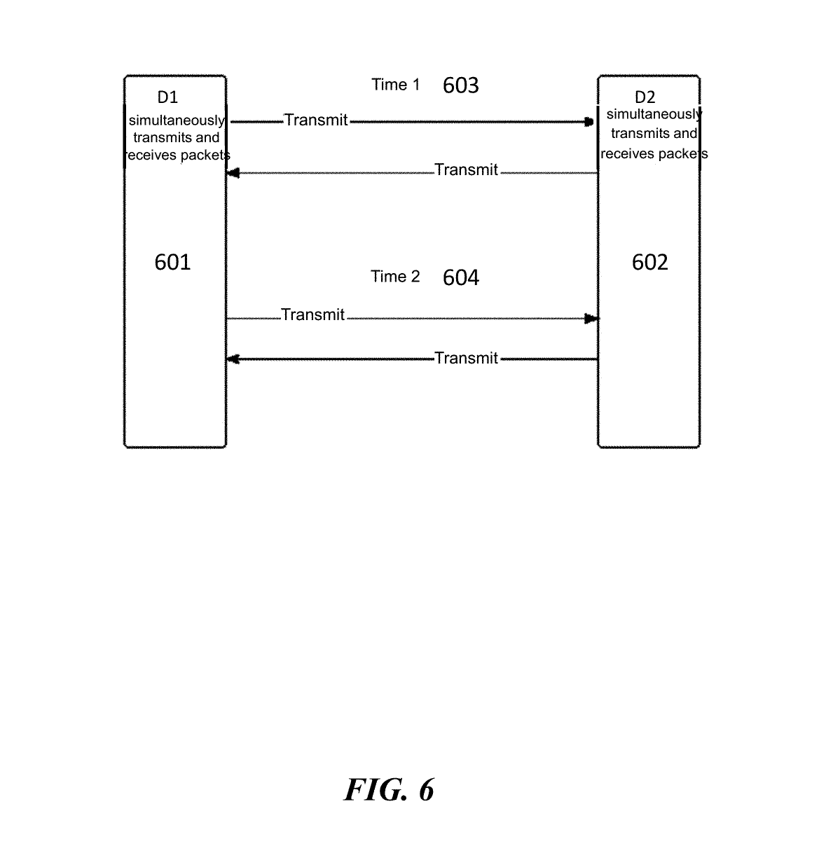

FIG. 6 shows a timeline of communication that can occur between a first badge 601 and a second badge 602. The first badge 601 and the second badge 602 can be within a proximity of each other such that a signal sent from either the first or second badge can have sufficient strength to reach a receiver on the second or first badge, respectively. The first badge and second badge can simultaneously send and receive information packets. The first badge can receive information packets from the second badge. The second badge can receive information packets from the first badge. While either or both of the first and second badges are sending and receiving information between each other the first and/or second badge can be scanning an area for other badges in the proximity. A badge can communicate with more than one other badge simultaneously. A badge can transmit a packet at least about every 1 second (s), 5 s, 10 s, 15 s, 20 s, 30 s, or 1 minute. A badge can check for other devices in the proximity at least about every 1 second (s), 5 s, 10 s, 15 s, 20 s, 30 s, 1 minute (min), 5 min, 10 min, or 15 min. As shown in FIG. 6 a first badge and a second badge can exchange packets at a first time 603 and again at a second time 604. Two or more badges can repeatedly exchange packets while they are in proximity of each other. The packets can comprise a time stamp such that the packets can be combined over a time period to determine how long the first and second badges were in proximity of each other.

The badge described herein can be configured to optimize power usage on the badge such that the badge can operate for a prolonged time interval without requiring charging or replacement of the battery on-board the badge. The badge can scan an area for signals emitted by other badges in the proximity of the badge periodically with a predetermined frequency. The scanning frequency can be modulated to decrease energy use by the badge when the badge is in a region with few other badges in its proximity.

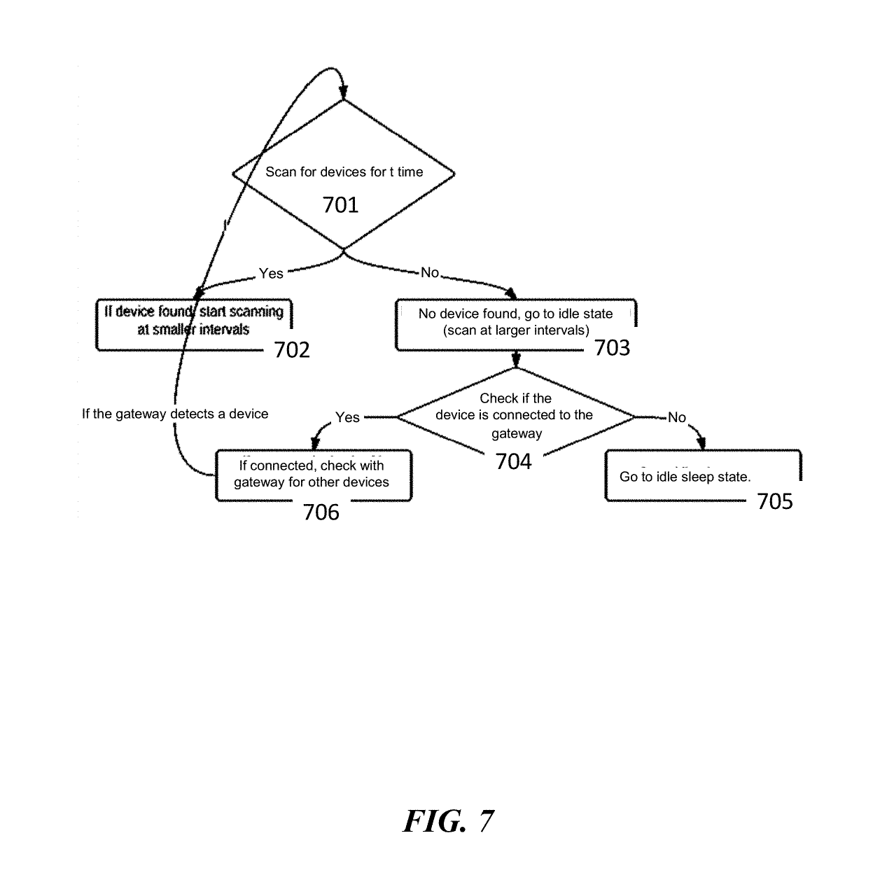

FIG. 7 shows a flow chart describing a process that can be implemented to modulate the scanning frequency of the badge in order to optimize power usage. A badge can scan for signals for signals from other badges in the proximity of the badge with an initial frequency 701. When one or more signals from other badges are detected the scanning frequency can increase relative to the initial frequency 702. Alternatively if signals from other badges in the proximity of the badge are not detected within a predetermine time period and/or predetermined number of scans the badge can operate in an idle state 703. In the idle state the badge can scan for signals from other badges in the proximity of the badge at a frequency that is lower than the initial frequency. When the badge enters an idle state the badge can update the payload information in a packet advertised by the badge such that the payload can inform other badges in the proximity of the badge that the badge is in an idle state.

The badge can remain in an idle state until it detects a signal from another badge or until the badge connects to a network gateway 704. Once in an idle state a badge can check if it is connected to a network gateway. If the badge is not connected to a network gateway and the badge does not detect either or both of a gateway or a signal from another badge within a predetermined time period and/or predetermined number of scans the badge can transition into a sleep state 705. Alternatively if the badge in an idle state is connected to a gateway, the badge can connect with the gateway. The gateway can inform the badge as to whether other badges are present in the proximity of the badge 706. If the gateway informs the badge that there are other badges in the proximity the badge can transition out of idle mode and can begin scanning at a frequency substantially equal to the initial frequency 701. In some cases the gateway can inform the badge that there are no badges in the proximity of the badge, when this occurs the gateway can instruct the badge to transition to sleep state. In some cases the gateway can instruct the badge to transition to sleep state based on a server request. The server request can instruct the gateway to transition the badge to sleep state regardless of whether badges are in the proximity of the badge.

The badge can be configured to operate in one or more operating states. In some cases, an operating state can be distinct such that a badge operating in a first operating state cannot simultaneously perform one or more actions associated with a second operating state. Alternatively, two or more operating states can be complementary such that a badge can operate in a first and second operating state simultaneously to perform one or more actions associated with the first operating state and one or more actions associated with the second operating state concurrently.

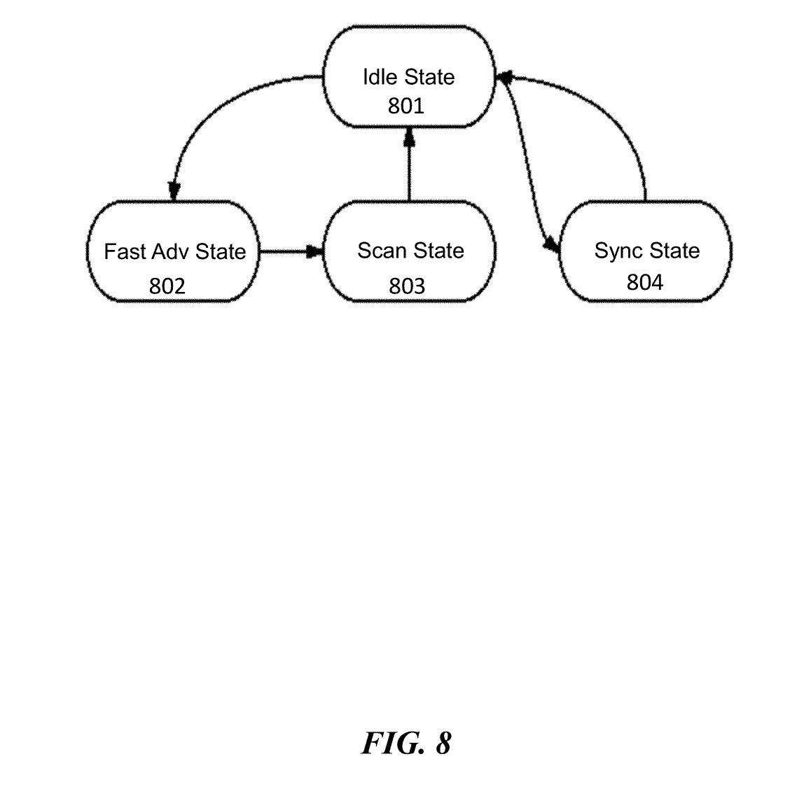

FIG. 8 describes operating states in which the badge can operate. A badge can operate in an idle state 801. When operating in an idle state the badge can scan and/or advertise at a relatively low frequency. For example, in an idle state a badge can scan with a frequency of at most about 50 Hz, 40 Hz, 30 Hz, 20 Hz, 10 Hz, 5 Hz, 4 Hz, 3 Hz, 2 Hz, 1 Hz, 0.1 Hz, 0.05 Hz, 0.01 Hz, 0.008 Hz, 0.005 Hz, 0.002 Hz, or 0.001 Hz. The frequencies for scanning for other badges and for advertising its own presence to other badges may or may not be the same. The badge may advertise its own presence to other badges at a frequency of at most 20 Hz, 10 Hz, 5 Hz, 1 Hz, or 0.1 Hz. A badge can transition into an idle state to extend battery life.

A badge can operate in a fast advertising state 802. When the badge is operating in a fast advertising state the badge can transmit packets at a relatively high frequency. For example, when the badge is operating in a fast advertising state the badge can advertise at a frequency of at least about 0.05 Hz, 0.08 Hz, 0.1 Hz, 0.5 Hz, 1 Hz, 10 Hz, 25 Hz, 50 Hz, 75 Hz, 100 Hz, 125 Hz, 150 Hz, 175 Hz, 200 Hz, 225 Hz, 250 Hz, 300 Hz, 350 Hz, 400 Hz, 500 Hz, 800 Hz, 1000 Hz, 1200 Hz, or 1600 Hz. The advertising rate in a fast advertising state can be at least about 2×, 3×, 4×, 5×, 10×, or 50× times higher than the advertising rate in an idle state. The packets can be received by other badges in the proximity of the badge. The badge can transition into a fast advertising state when the badge detects a population of other badges in the proximity of the badge above a threshold population value.

Additionally, the badge can operate in a scanning state 803 when the badge detects a population of other badges in the proximity of the badge above a threshold population value. The badge can scan for signals from other badges at a relatively high frequency when the badge is in the scanning state. For example, when the badge is operating in a scanning state the badge can scan at a frequency of at least about 0.00003 Hz, 0.00007 Hz, 0.0002 Hz, 0.0005 Hz, 0.001 Hz, 0.005 Hz, 0.01 Hz, 0.05 Hz, 0.1 Hz, 1 Hz, 10 Hz, 50 Hz, 75 Hz, 100 Hz, 125 Hz, 150 Hz, 175 Hz, 200 Hz, 225 Hz, 250 Hz, 300 Hz, 350 Hz, 400 Hz, 500 Hz, 800 Hz, 1000 Hz, 1200 Hz, or 1600 Hz. The badge can operate in a scanning state and fast advertising state concurrently or sequentially. In some cases, the badge can switch between a scanning state and a fast advertising state periodically with a predetermined frequency and period. The badge can operate in a sync state 804. When the badge operates in the sync state the badge can be connected to a network gateway. The badge can exchange data periodically with the gateway when the badge is in sync state, for example, the badge can exchange data relating to signal strength, time, and/or battery life.

A badge can toggle between different operating states to optimize power usage, transfer data, and/or communicate with other badges in the proximity of the badge. A badge can operate in a sync state while the badge is being initialized. Initialization of the badge can comprise assigning the badge a unique ID, choosing privacy settings, and/or specifying threshold values that can be used to transition a badge between idle and active states (e.g., scanning and fast advertising states). During the sync state the badge can sync a badge time keeper with a gateway time keeper, the badge can periodically transition back to the sync state to sync time with the gateway time keeper to ensure that the badge time keeper remains accurate. The badge can then transition into an advertising state. The badge can simultaneously or sequentially operate in an advertising and scanning state. While operating in the scanning and/or advertising state the badge can receive data packets from other badges the data packets can be stored locally on a memory storage badge on-board the badge. The badge can periodically return to the sync state to send the data from the memory storage badge on the badge to a memory storage badge accessible through the network gateway. Whenever the number of badges in the proximity of the badge falls below a predetermined threshold the badge can transition to an idle state to conserve battery power.

Badges can be provided to a group of individuals at an event. The event can comprise vendors that provided a product or service that can be of interest to at least a fraction of the individuals at the event, attractions that can be attended by at least a fraction of the individuals at the event, and/or networking opportunities where individuals in the group of individuals can meet. The event can be, for example, a convention, conference, sporting event, music event, networking event, fair, and/or shopping event. As an individual in the group traverses an area comprising the event a badge worn by and associated with the individual can scan for and/or advertise to other badges in the proximity of the individual. A badge worn by the individual can generate a time history of which other individuals were interacted with while the individual in traversed the area comprising the event. Other individuals can include other individuals in the group, vendors, and individuals involved in attractions that were attended by the individual.

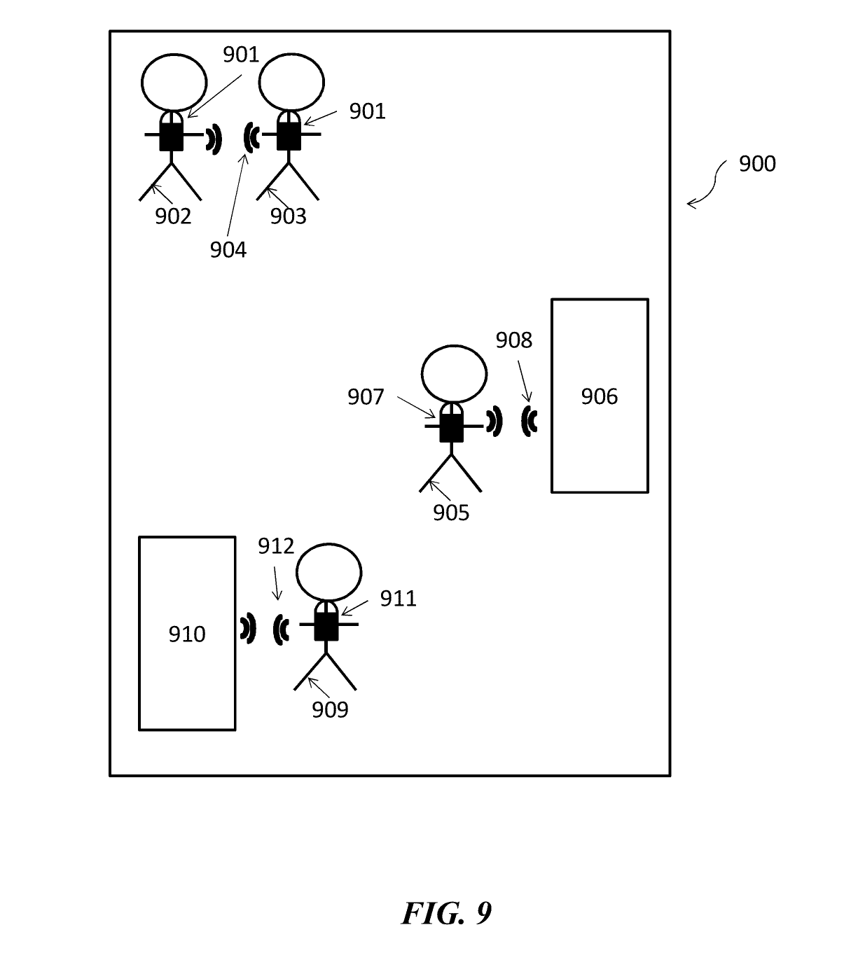

FIG. 9 shows an area 900 where an event is attended by a group of individuals wearing badges 901. The badges can be continuously scanning for and/or advertising to other badges in the area. Two or more individuals 902 and 903 can be in a proximity of each other such that the badges 901 worn by the individuals are in a proximity of each other. The badges worn by the individuals 902 and 903 can transmit data packets 904 to each other. The badges can transmit data packets without routing the data through a central server. The badges can transmit data packets based only on proximity. The badges can transmit data packets automatically when two or more devices are in proximity of each other without an instruction from a processor. The data packets can comprise contact information for each of the individuals. The data packets can additionally comprise a time stamp. The time stamp can be used to indicate when the individuals met (e.g., came within the proximity of each other) and how long the individuals were within the proximity of each other.

An individual 905 in the area 900 can approach a vendor 906. The vendor can be an individual or a group of individuals that are selling and/or advertising a good and/or service. The individual 905 can interact with the vendor 906 to purchase the service and/or good and/or to collect marketing materials and/or information about the good and/or service provided by the vendor. The vendor 906 can have a badge that can communicate with a badge 907 worn by the individual 905. The badge 907 worn by the individual 905 and a badge of the vendor can transmit data packets 908 to each other. The data packets from the badge worn by the individual can comprise contact information for associated with the individuals 905. The data packets from the badge of the vendor can comprise contact information, marketing information, and/or identifying information for the vendor. The data packets 908 can additionally comprise a time stamp, a weblink, and/or device telemetry data. The time stamp can be used to indicate when the individual approached the vendor and/or how long the individual and the vendor were within the proximity of each other.

An individual 909 in the area 900 can approach an attraction 910. The attraction can be a speaker, performance, video, lecture, show, or any other attraction of interest to the individual provided in the area 900. The individual 909 can interact with the attraction 910 to learn about a topic or for the purpose of entertainment. The attraction 910 can have a badge that can communicate with a badge 911 worn by the individual 909. The badge 911 worn by the individual 909 and a badge of the attraction can transmit data packets 912 to each other. The data packets from the badge worn by the individual can comprise contact information for associated with the individuals 909. The data packets from the badge of the attraction can comprise contact information, marketing information, and/or identifying information for the attraction. The data packets 912 can additionally comprise a time stamp. The time stamp can be used to indicate when the individual approached the attraction and/or how long the individual and the attraction were within the proximity of each other.

Each individual can interact with any combination of vendors, attractions, and/or other individuals in the area 900. Each individual can receive a summary report that provides information to the individual about the vendors, attractions, and/or other individuals that the individual interacted with in the area. The information can comprise at least the information received by the badge while the individual was interacting with the vendors, attractions, and/or other individuals. In some cases, the information in the summary report can comprise additional information such as additional marketing materials. The information in the summary report can comprise links associated with social media pages or other web based data bases where an individual can find additional information about the vendors, attractions, and/or other individuals that the individual interacted with.

Each individual can have different ways of interaction with other individuals. Some individuals may connect with more people than others. Therefore the badges associated with some individuals in the network may store more data than the badges of other individuals. Because an individual badge may have a limited storage capacity, e.g., a limited memory for storing data, after frequent interactions with other badges associated with people, venues, vendors, advertisements, and/or attractions, the available storage capacities of some badges may become low. When a storage capacity of a badge is below a predetermined threshold value, e.g., an available space in its memory is lower than a predetermined threshold value, this badge can leverage the memories or storage capacities of other badges which may have more available storage capacities.

The badge that has low available storage capacity (e.g., low memory badge) may scan for one or more other badges in the connected mesh network which have more available storage capacities to distribute the data associated with the low memory badge. The low memory badge may receive information regarding available storage capacity of other badges. For example, the packets exchanged between badges may include real-time memory usage information in the header or the payload of an individual packet. This may be implemented by pre-setting format of packet content transmitted between badges. Alternatively or additionally, the low memory badge may send requests to one or more detected badges to receive memory usage information. The requests may be sent automatically when the memory level drops to a predetermined threshold value, or the requests may be sent as triggered by a user input. The detected other badges may process the requests and return the individual memory usage information to the low memory badge in response to the requests.

As discussed elsewhere herein, the low memory badge may detect one or more other badges, determine whether the detected one or more other badges are connected to a network gateway, and transmit data to the one or more other badges that are connected to the network gateway. The data may be distributed, respectively or collectively, to one or more other badges with available storage capacities that are connected to the network gateway.

The other one or more badges with available storage capacities may then transmit the data and/or associated timestamp information from the low memory badge to a network hub. In some instances, the data packets transmitted from the low memory badge may include identifying information (e.g., in packet header and/or payload) such that these data packets can be distinguished from the data packets that are intended for the other one or more badges. For example, these packets may be specifically marked, or as discussed elsewhere herein, the badge identifier and/or the timestamp in the packets may be used for identification. Alternatively or additionally, the data packets from the low memory badge may be stored in separate segment(s) or section(s) of the memories of the other badges from the segment(s) or section(s) used for storing data packets intended for the other one or more badges. The low memory badge may later retrieve the data from the network hub when it restores enough available storage capacities, e.g., when the available storage capacity is above or equal to the predetermine threshold value. Alternatively or additionally, the user or owner of the low memory badge may retrieve the data from the network hub using one or more user devices after certain user identity are verified.

The process of leveraging the storage capacities of nearby badges as described herein can be used in various embodiments. For example, a user can collect certain information from the event and then distribute the collected information partially or entirely to various nearby badges with low memory utilization and/or with available storage capacity. In some instances, the user may have the options of selecting which one or more detected badges to distribute the information to. The user may also have the options to choose which piece of information to be distributed to the individual badges/users.

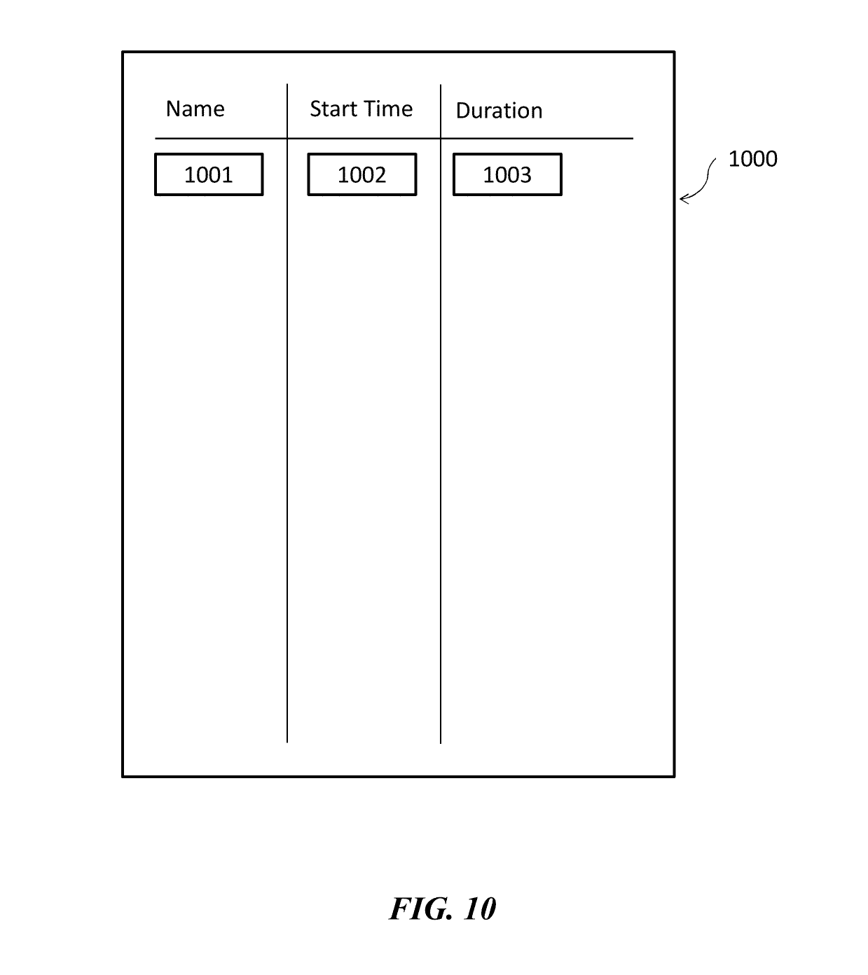

The summary report can be provided to the individual in an email, postal mailer, text message, voice message, or social media inbox message. In some cases the summary report can be provided to the individual through a user interface provided in an application associated with the badge. The application can be the same application used by the individual to communicate with the badge to adjust privacy settings. The application can be executed on an electronic device, for example, a smartphone, computer, or tablet. The application can have a display (e.g., screen) that provides a user interface to the individual. The summary report can be provided to the individual through the user interface. FIG. 10 shows an example of a summary report 1000 that can be provided to an individual on the user interface. The summary report can comprise the name or title 1001 of the individual, vendor, or attraction that the individual interacted with. In some cases the name or title 1001 can be a link to more information about the individual, vendor, or attraction on an external webpage or a new window within the application. The summary report can additionally comprise a time stamp 1002 that indicates when the individual approached the individual, vendor, or attraction and a duration 1003 describing how long the individual was in the vicinity of the individual, vendor, or attraction.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method of exchanging information in an environment between users, the method comprising
transmitting, from a badge, without routing through a network gateway, a signal with a packet comprising an identifier and a time stamp;
receiving, at the badge, without routing through the network gateway, one or more signals with packets that contain data comprising an identifier and a time stamp from one or more other badges, wherein the badge simultaneously transmits the packet and receives the one or more packets;
connecting to the network gateway; and
transmitting data from the one or more packets to a hub through the network gateway.

2. The method of claim 1, wherein the badge connects directly to the network gateway.

3. The method of claim 1, wherein the badge connects to the network gateway by hopping to a badge that is directly connected to the network gateway.

4. The method of claim 1, wherein the badge is a wearable device.

5. The method of claim 1, wherein the environment is an event environment.

6. The method of claim 1 further comprising, providing a summary report of packets that were received in the environment.

7. The method of claim 1, wherein the signal is a Bluetooth signal.

8. The method of claim 1, further comprising:
determining whether the one or more other badges are connected to the network gateway; and
transmitting data to at least one other badge when the at least one other badge is connected to the network gateway.

9. The method of claim 8, further comprising: transmitting the data to the network gateway via a path comprising a smallest number of hops between any two of the one or more other badges that are connected to the network gateway.

10. The method of claim 9, further comprising reviewing packets received from the one or more other badges, and wherein the packets received from the one or more other badges comprise at least connection status to the network gateway, signal strength, or distance from the network gateway.

11. The method of claim 8, further comprising synchronizing respective time keepers of the badge and the at least one other badge when the at least one other badge is connected to the network gateway.

12. The method of claim 8, further comprising:
determining whether an available storage capacity of the badge is below a predetermined threshold value; and
transmitting the data to the at least one other badge when the available storage capacity is below the predetermined threshold value.

13. The method of claim 12, further comprising receiving information associated with storage capacity of the at least one other badge.

14. The method of claim 12, further comprising retrieving the data transmitted to the at least one other badge when the available storage capacity of the badge is restored to equal to or above the predetermined threshold value.

15. An electronic badge for exchanging information in an environment between users, the electronic badge comprising:
a communication interface configured to transmit, without routing through a network gateway, a signal with a packet comprising an identifier and a time stamp; and
a computer processor in communication with the communication interface, wherein the computer processor is programmed to:
receive, without routing through the network gateway, one or more signals with packets that contain data comprising an identifier and a time stamp from one or more other badges, wherein the electronic badge simultaneously transmits the packet and receives the one or more packets; and
generate signals for connecting to the network gateway,
wherein the communication interface is further configured to transmit data from the one or more packets to a hub through the network gateway when the electronic badge is connected to the network gateway.

16. The electronic badge of claim 15, further comprising one or more sensors configured to detect location or movement of the electronic badge.

17. The electronic badge of claim 15, further comprising a display having a graphical user interface for showing information associated with the one or more other badges.

18. The electronic badge of claim 15, wherein the communication interface is further configured to be in network communication with an electronic device having a display having a graphical user interface for showing information associated with the one or more other badges.

19. The electronic badge of claim 15, wherein the computer processor is configured to receive, without routing through the network gateway, one or more signals from the one or more other badges at difference scanning frequencies when the electronic badge operates in different modes.

20. The electronic badge of claim 15, wherein the communication interface is configured to transmit the signal without routing through a network gateway at different advertising frequencies when the electronic badge operates in different modes.
